(19) United States
(12) Patent Application Publication
(10) Pub. No.: US 2019/0001220 A1
(43) Pub. Date: Jan. 3, 2019

(54) VIDEO GAME PROCESSING PROGRAM, AND VIDEO GAME PROCESSING SYSTEM

(71) Applicant: SQUARE ENIX CO., LTD., Tokyo (JP)

(72) Inventors: Yoshinori AOYAGI, Tokyo (JP); Mitsuru KAWAHARA, Tokyo (JP); Mitsuru NAKASHIMA, Tokyo (JP)

(73) Assignee: SQUARE ENIX CO., LTD., Tokyo (JP)

(21) Appl. No.: 16/064,588

(22) PCT Filed: Jan. 29, 2016
(86) PCT No.: PCT/JP2016/000474

§ 371 Date: Jun. 21, 2018

(30) Foreign Application Priority Data
Dec. 22, 2015 (JP) 2015-249512

(51) Int. Cl. A63F 13/30; A63F 13/795; A63F 13/798

(52) U.S. Cl. CPC A63F 13/30; A63F 13/795; A63F 2300/558; A63F 2300/556; A63F 13/798

(57) ABSTRACT

It becomes possible to improve interest in or the taste of a video game in which a plurality of players who constitute a party cooperates with each other to solve various tasks. A user who satisfies a predetermined condition defined in advance is set to a beginner. A user who satisfies a specific condition defined in advance is set to a leader. A privilege is given to at least a part of a plurality of users who constitute a party including the leader and the beginner among parties each of which is constituted by a plurality of users.

### TECHNICAL FIELD

At least one of embodiments according to the present invention relates to a video game processing program and a video game processing system for causing a server to realize functions to control progress of a video game in response to an operation of a user.

### BACKGROUND ART

Heretofore, in a field of video games, various systems configured to cause a plurality of players who constitute a party (referred to also as a group, a team, a guild and the like) cooperates with each other to solve various tasks have been proposed.

In such a system, there is one that has a mechanism to encourage players to reconstitute a party, for example (see Patent Document 1).

### RELATED ART DOCUMENTS

### Patent Documents

### Patent Document 1

Japanese Patent Application Publication No. 2015-192752

### SUMMARY OF INVENTION

### Problems to be Solved by the Invention

A conventional game system has an effect to encourage a person (or a player) who plays a video game to reconstitute a party. However, in recent years, a demand to have connection with other players via the video game even between a beginner and an expert becomes larger compared with conventional one. For that reason, in the conventional system, it may be impossible to sufficiently improve interest in or the taste of a video game in which a plurality of players who constitute a party cooperates with each other to solve various tasks.

It is an object of at least one of embodiments according to the present invention to solve the problems described above, and to improve interest in or the taste of a video game in which a plurality of players who constitute a party cooperates with each other to solve various tasks.

### Means for Solving the Problems

According to one non-limiting aspect of the present invention, a video game processing program according to one embodiment of the present invention is a video game processing program for causing a server to realize functions to control progress of a video game in response to an operation of a user, wherein the functions include: a beginner setting function configured to set a user who satisfies a predetermined condition defined in advance to a beginner; a leader setting function configured to set a user who satisfies a specific condition defined in advance to a leader; and a privilege giving function configured to give a privilege to at least a part of a plurality of users who constitute a party including the leader and the beginner among parties each of which is constituted by a plurality of users.

According to another non-limiting aspect of the present invention, a video game processing system according to one embodiment of the present invention is a video game processing system for controlling progress of a video game in response to an operation of a user, the video game processing system including a communication network, a server, and a user terminal, the video game processing system including: a beginner setting unit configured to set a user who satisfies a predetermined condition defined in advance to a beginner; a leader setting unit configured to set a user who satisfies a specific condition defined in advance to a leader (or a mentor); and a privilege giving unit configured to give a privilege to at least a part of a plurality of users who constitute a party including the leader and the beginner among parties each of which is constituted by a plurality of users.

### Effects of the Invention

According to each of the embodiments of the present application, one or two or more shortages are solved.

### BRIEF DESCRIPTION OF DRAWINGS

FIG. 1 is a block diagram showing an example of a configuration of a video game processing system corresponding to at least one of embodiments according to the present invention.

FIG. 2 is a block diagram showing a configuration of a video game processing server corresponding to at least one of the embodiments according to the present invention.

FIG. 3 is a flowchart showing an example of game processing corresponding to at least one of the embodiments according to the present invention.

FIG. 4 is a flowchart showing an example of an operation of a server side in game processing corresponding to at least one of embodiments according to the present invention.

FIG. 5 is a block diagram showing a configuration of the video game processing server corresponding to at least one of the embodiments according to the present invention.

FIG. 6 is a flowchart showing an example of the game processing corresponding to at least one of the embodiments according to the present invention.

FIG. 7 is an explanatory drawing for explaining an example of a display screen corresponding to at least one of the embodiments according to the present invention.

FIG. 8 is a block diagram showing a configuration of the video game processing server corresponding to at least one of the embodiments according to the present invention.

FIG. 9 is a flowchart showing an example of the game processing corresponding to at least one of the embodiments according to the present invention.

FIG. 10 is a block diagram showing a configuration of the video game processing server corresponding to at least one of the embodiments according to the present invention.

FIG. 11 is a flowchart showing an example of the game processing corresponding to at least one of the embodiments according to the present invention.

FIG. 12 is a block diagram showing a configuration of the video game processing server corresponding to at least one of the embodiments according to the present invention.

FIG. 13 is a flowchart showing an example of the game processing corresponding to at least one of the embodiments according to the present invention.

FIG. 14 is a block diagram showing a configuration of the video game processing server corresponding to at least one of the embodiments according to the present invention.

FIG. 15 is a flowchart showing an example of the game processing corresponding to at least one of the embodiments according to the present invention.

### DESCRIPTION OF EMBODIMENTS

Hereinafter, examples of embodiments according to the present invention will be described with reference to the drawings. In this regard, various kinds of elements in an example of each embodiment, which will be described below, can appropriately be combined with each other in a range where contradiction or the like does not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like does not occur in the content of the processing.

### First Embodiment

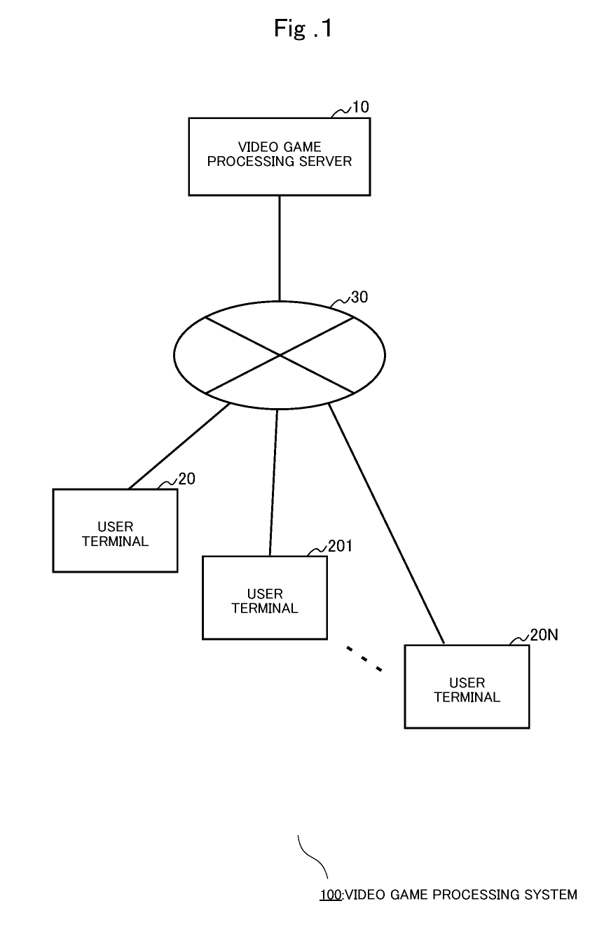

FIG. 1 is a block diagram showing an example of a configuration of a video game processing system 100 according to one embodiment of the present invention. As shown in FIG. 1, the video game processing system 100 includes a video game processing server 10 (hereinafter, referred to as a “server 10”) and user terminals 20, 201 to 20N (“N” is an arbitrary integer) respectively used by users of the video game processing system. In this regard, a configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20, 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The video game processing system 100 includes the server 10 and the plurality of user terminals 20, 201 to 20N, whereby various kinds of functions for carrying out various processes in response to an operation of the user are realized.

The server 10 is managed by an administrator of the video game processing system 100, and has various kinds of functions to provide information regarding various processes to each of the plurality of user terminals 20, 201 to 20N. In the present embodiment, is constructed by an information processing apparatus, such as a WWW server, and includes a storage medium for storing various kinds of information. In this regard, the server 10 is provided with a general configuration for carrying out the various processes as a computer, such as a control section and a communicating section. However, its explanation herein is omitted. Further, in the video game processing system 100, it is preferable that the server 10 manages various kinds of information from a point of view to reduce a processing load on each of the plurality of user terminals 20, 201 to 20N. However, the storing unit for storing the various kinds of information may include a storage region with a state that the server 10 can access the storage region. For example, the server 10 may be configured so as to be provided with a dedicated storage region outside the server 10.

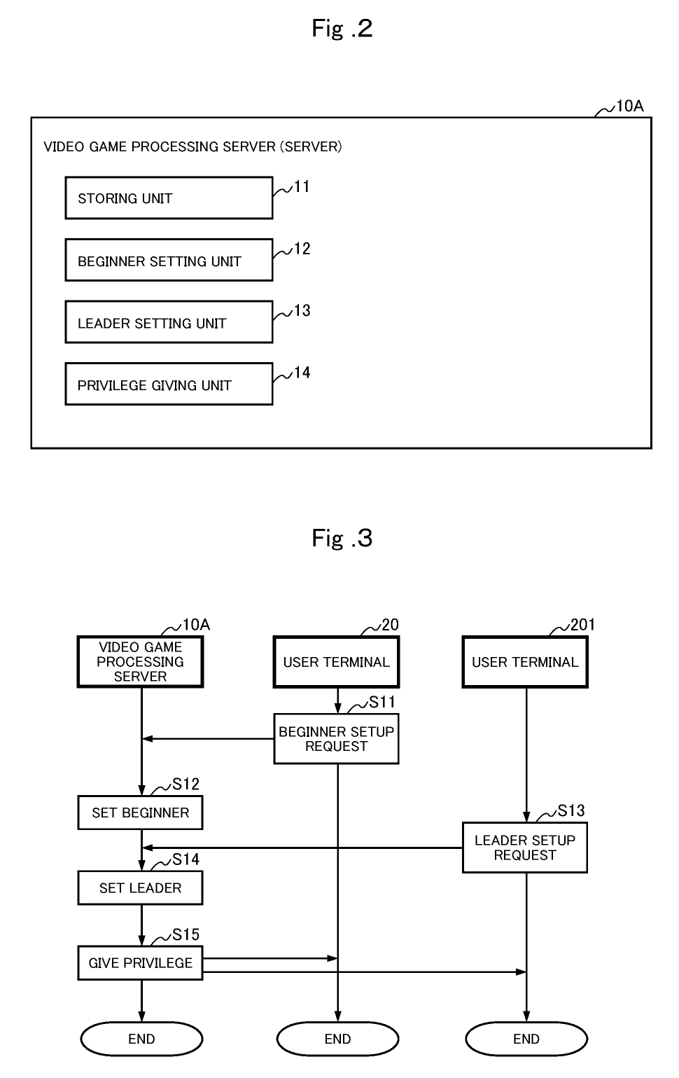

FIG. 2 is a block diagram showing a configuration of a video game processing server 10A (hereinafter, referred to as a “server 10A”), which is an example of the configuration of the server 10. As shown in FIG. 2, the server 10A at least includes a storing unit 11, a beginner setting unit 12, a leader setting unit 13, and a privilege giving unit 14.

The storing unit 11 has a function to store party information that indicates various kinds of information regarding parties each of which is constituted by a plurality of players in a video game.

Here, the party information means various kinds of information regarding the parties each of which is formed by a plurality of players. A configuration of the party information is not limited particularly so long as it is information regarding the parties. However, in the present embodiment, a status of each of the players who constitute a party is contained therein. In the status, information by which it is possible to specify whether each of the players is a leader (or a mentor), a beginner (or a novice), or neither the leader or beginner is contained.

The beginner setting unit 12 has a function to set a status of a player to a beginner in a case where the player satisfies a predetermined condition defined in advance. The predetermined condition may be any one so long as it is a condition defined for identifying to be a beginner.

The beginner setting unit 12 may determine that the predetermined condition is satisfied in a case where a new player is registered, for example, and set a status of the player to a beginner. Further, the beginner setting unit 12 may determine whether the predetermined condition is satisfied or not in a case where a beginner setup request is received from the user, for example, and set the status of the user (or player) to the beginner in a case where it is satisfied.

The leader setting unit 13 has a function to set a status of a player to a leader in a case where the player satisfies a specific condition defined in advance. The specific condition may be any one so long as it is a condition defined for identifying that a player is a leader.

The leader setting unit 13 may set the status of the player to the leader, for example, in a case where a level of the player becomes a specific level or more, in a case where the player obtains a specific item, in a case where the player clears stages of the specific number, in a case where the player obtains points of the specific number, in a case where the player consumes points of the specific number, or in a case where some or all of these is satisfied. Further, the leader setting unit 13 may determine whether the specific condition is satisfied or not in a case where a leader setup request is received from the user, for example, and set the status of the user (or player) to the leader in a case where it is satisfied.

The privilege giving unit 14 has a function to give a privilege to each of the users who constitute a party including the leader and the beginner among parties each of which is constituted by a plurality of users.

The privilege giving unit 14 gives the privilege to each of users who constitute a party in a case where the party including the beginner and the leader is constituted, for example. In this regard, for example, the privilege giving unit 14 may give the privilege to only a player who is the beginner and a player who is the leader. In this regard, the privilege may be any kind of privilege such as an item and a point. Further, a configuration to give the privilege to each of the users who constitute the party is not limited particularly. For example, the privilege giving unit 14 may be configured so as to give a privilege to at least a part of users (for example, a user that satisfies a giving condition) of a plurality of users who constitute a party. Namely, the privilege giving unit 14 may be configured so as to determine whether to give the privilege to each of the users or not. As examples of such a configuration, there are a configuration in which a privilege is given to only a beginner or a leader, and a configuration in which a difference between a privilege to be given to a beginner and a privilege to be given to a leader is provided.

Each of the plurality of user terminals 20, 201 to 20N is managed by a user, and is configured by a communication terminal, such as a cellular phone terminal, a PDA (Personal Digital Assistants), and a mobile game device, by which the user can play a network delivery type game, for example. In this regard, a configuration of the user terminal that the video game processing system 100 can include is not limited to the examples described above. However, the user terminal may be configured so that the user can recognize the video game. As the other example of the configuration of the user terminal, there is a so-called wearable divide such as a smart watch, a combination of the wearable device and the communication terminal, and the like.

Further, each of the plurality of user terminals 20, 201 to 20N is connected to the communication network 30, and includes hardware (for example, a display device for displaying a browser screen and/or a game screen according to a coordinate, and the like) and software for carrying out various kinds of processes by carrying out communication with the server 10. In this regard, each of the plurality of user terminals 20, 201 to 20N may be configured so as to be capable of directly communicating with each other without the server 10.

Next, an operation of the video game processing system 100 (hereinafter, referred to as the “system 100”) according to the present embodiment will be described.

FIG. 3 is a flowchart showing an example of the game processing carried out by the system 100. In the game processing according to the present embodiment, processing related to giving of a privilege according to a configuration situation of a party is carried out. Hereinafter, the case where the server 10A, the user terminal 20 (hereinafter, referred to as the “terminal 20”) and the user terminal 201 (hereinafter, referred to as the “terminal 201”) carry out the game processing will be described as an example.

In the game processing, the terminal 20 carries out a beginner setup request to the server 10A (Step S11).

When the beginner setup request is received from the terminal 20, the server 10A determines whether a player of the terminal 20 satisfies a predetermined condition defined in advance or not. In a case where the player satisfies it, the server 10A sets a status of the player to a beginner (Step S12). In this regard, in a case where he or she does not satisfy the predetermined condition, the server 10A notifies the terminal 20 that the player cannot be set to the beginner, for example.

On the other hand, in the game processing, the terminal 201 carries out a leader setup request to the server 10A (Step S13).

When the leader setup request is received from the terminal 201, the server 10A determines whether a player of the terminal 201 satisfies the specific condition defined in advance or not, and sets a status of the player to a leader in a case where he or she satisfies it (Step S14). In this regard, in a case where the specific condition is not satisfied, the server 10A notifies the terminal 201 that the player cannot be set to the leader, for example.

The server 10A then confirms a configuration situation of each of the parties. In a case where a party including a leader and a beginner newly exists, the server 10A gives a privilege to each of users who constitute the party (in the present embodiment, the player of the terminal 20 and the player of the terminal 201) (Step S15).

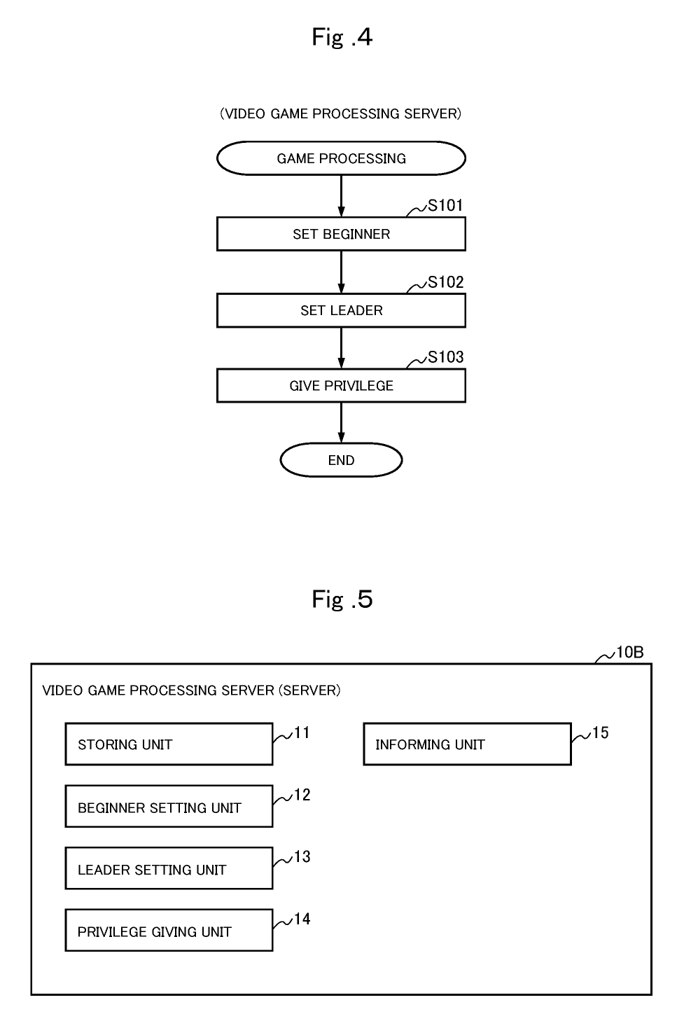

FIG. 4 is a flowchart showing another example of the game processing carried out by the system 100. In the game processing according to the present embodiment, processing related to giving of a privilege according to a configuration situation of a party is carried out. Hereinafter, the case where the server 10A carries out the game processing will be described as an example.

In a case where a player who satisfies the predetermined condition defined in advance newly exists at predetermined timing (for example, when it becomes a time defined in advance, when there is user registration, or the like) , the server 10A sets a status of the player to a beginner (Step S101). In this regard, the server 10A may confirm whether the player hopes beginner setting or not in a case where a player who satisfies the predetermined condition newly exists; and set the player to a beginner in a case where the player hopes so.

Further, in a case where a player who satisfies the specific condition defined in advance newly exists at specific timing (for example, when it becomes a time defined in advance, or the like), the server 10A sets a status of the player to a leader (Step S102). In this regard, the server 10A may confirm whether the player hoses leader setting or not in a case where a player who satisfies the specific condition newly exists; and set the player to a leader in a case where the player hopes so.

The server 10A then confirms the configuration situation of each of parties. In a case where a party including a leader and a beginner newly exists, the server 10A gives a privilege to each of users who constitute the party (Step S103). In this regard, the process at Step S103 is carried out when it becomes a time defined in advance, when a party is newly constituted, or when a configuration of a party is changed, for example.

As explained above, as one side of the first embodiment, the server 10A including the functions to control progress of the video game in response to the operation of the user is configured so as to include the beginner setting unit 12, the leader setting unit 13, and the privilege giving unit 14. Thus, the beginner setting unit 12 sets the user who satisfies the predetermined condition defined in advance to the beginner; the leader setting unit 13 sets the user who satisfies the specific condition defined in advance to the leader; and the privilege giving unit 14 gives the privilege to each of the users who constitute the party including the leader and the beginner among parties each of which is constituted by a plurality of users. Therefore, it is possible to improve interest in or the taste of the video game in which a plurality of players who constitute a party cooperates with each other to solve various tasks.

Namely, since it is possible to encourage each of the users to constitute a party including a leader and a beginner, it is possible to improve interest in or the taste of the video game. Further, it is possible to encourage a player who aims at a leader to satisfy the specific condition for identifying a leader. This makes it possible to improve interest in or the taste of the video game. Moreover, it is possible to encourage a player identified as a leader to play the video game so as to be eligible as the leader. This makes it possible to improve interest in or the taste of the video game.

### Second Embodiment

FIG. 5 is a block diagram showing a configuration of a video game processing server 10B (hereinafter, referred to as a “server 10B”), which is an example of the video game processing server 10. In the present embodiment, the server 10B at least includes a storing unit 11, a beginner setting unit 12, a leader setting unit 13, a privilege giving unit 14, and an informing unit 15.

The informing unit 15 has an informing function to inform of being a leader. A configuration to inform of being a leader is not limited particularly. However, it is preferable that it is a configuration in which in a case where a game screen, on which a player character of a player who is set to a leader is displayed, is displayed on a display screen of a display device included in each of the terminals 20, 201 to 20N, an icon indicating to be the leader or the like is displayed in the vicinity of the player character.

Here, the game screen means a screen that shows a virtual space (or a game space). In this regard, in the present embodiment, various kinds of elements that constitute a game screen may be referred to as an “image”. A configuration of the game screen is not limited particularly so long as the user can recognize a status of a video game.

Further, the phrase “cause the display device to display the game screen on the display screen” means that the display device included in the user terminal 20 or the like is caused to output the game screen by means of communication using the communication network 30. As an example of the configuration to cause the display device to display the game screen, there is a configuration in which information generated at the server 10 side (hereinafter, referred to as “output information”) is transmitted to a user terminal side. In this regard, a configuration of the output information is not limited particularly. The output information may be information in which an image is compressed, or information for causing the terminal side to generate an image, for example. As an example of the information in which the image is compressed, there is one used in a cloud game (for example, MPEG). Further, as information for generating an image at the terminal side, there is one used in an online game (for example, positional information of an object).

FIG. 6 is a flowchart showing an example of the game processing carried out by the server 10. Hereinafter, an operation of the server 10B will be described as an example. In this regard, herein, explanation for other processes than the process of the informing unit 15 is omitted from a point of view to avoid repeated explanation.

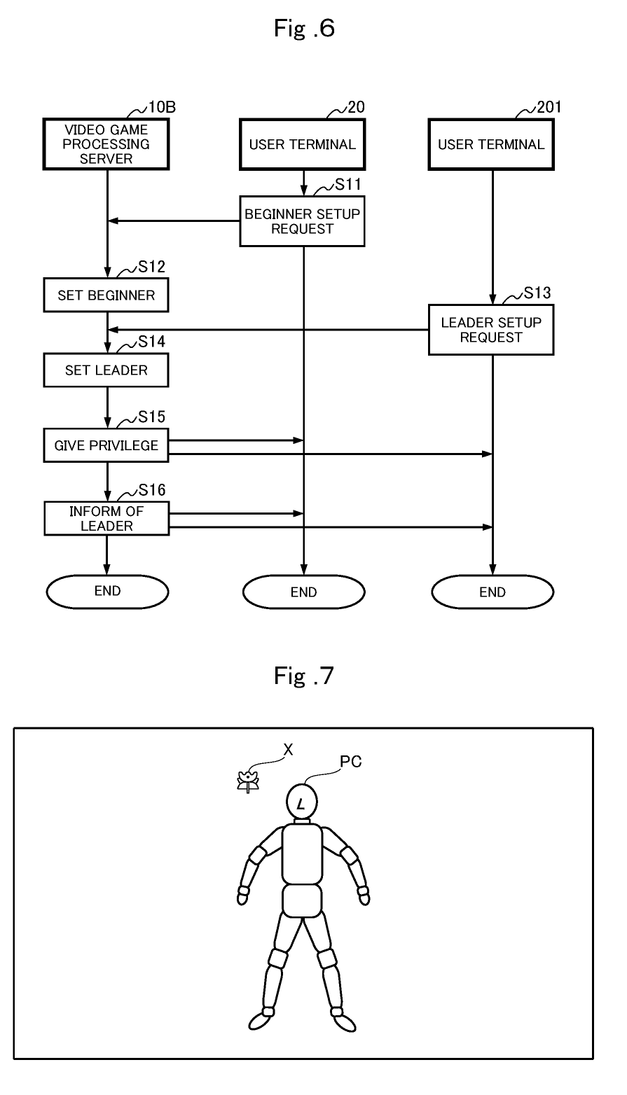

The server 10B causes each of the user terminals 20, 201 to display an icon X (see FIG. 7) in the vicinity of a player character PC (see FIG. 7) of a player who is set to a leader (here, a player of the user terminal 201) in a case where the player character PC is caused to appear on a game screen, thereby informing that the displayed player character is a character identified to be the leader (Step S16). Namely, a game screen in which the icon X is displayed in the vicinity of the player character PC is displayed on the display screen of the display device included in each of the user terminals 20, 201.

As explained above, as one side of the second embodiment, the server 10B includes the informing unit 15. Thus, it is possible to inform each of the players (which are not limited to players of the same party) that the player character of the player set to the leader is set as the leader.

It has not mentioned in each of the embodiments described above. However, matching of a player set to a leader with a player set to a beginner may be carried out. In this case, for example, a party that includes at least two players respectively set to a leader and a beginner may be constituted at random among players who hope matching.

It has not mentioned in each of the embodiments described above. However, setting of a leader may be released in response to a request from a player set to the leader or a request from the other player. In case of the request from the other player, a release condition such as a condition that there are requests from a plurality of other players may be provided.

It has not mentioned in each of the embodiments described above. However, a player set to a leader can carry out a guide of the video game (guides such as an operation method, a point of view of a screen, party play, a text command, a configuration and the like) to the players in the same party who are set to the beginner by using chat and the like. In this regard, the server may be configured so that the player set to the leader can guide a player who is set to neither a beginner nor a leader.

In each of the embodiments described above, it is configured so as to set a player who satisfies the condition to the beginner or the leader. However, it may be configured so as to give a player the qualification to become a beginner or a leader, and carry out setting or release of the beginner or the leader by an operation of the player to which the qualification is given.

It has not mentioned in each of the embodiments described above. However, it may be informed that it is a character of a player set to a beginner by means of an icon or the like.

### Third Embodiment

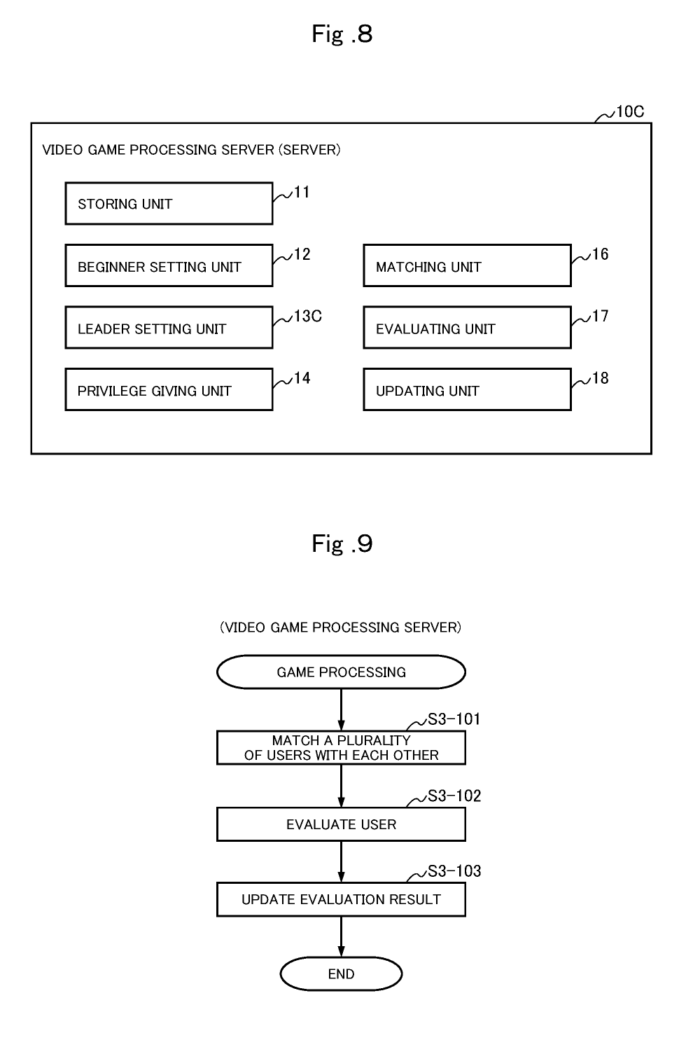

FIG. 8 is a block diagram showing a configuration of a video game processing server 10C (hereinafter, referred to as a “server 10C”), which is an example of the video game processing server 10. In the present embodiment, the server 10C at least includes a storing unit 11, a beginner setting unit 12, a leader setting unit 13C, a privilege giving unit 14, a matching unit 16, an evaluating unit 17, and an updating unit 18.

The matching unit 16 has a function to carry out matching of a plurality of users.

Here, the phrase “matching” means combination. A configuration to carry out matching of the plurality of users is not limited particularly. However, it is preferable that the configuration is a configuration in which the user can recognize at least a part of a matching condition. As an example of such a configuration, there is a configuration in which other user who satisfies a matching condition selected by the user is matched with the user.

The evaluating unit 17 has a function to cause a user who satisfies an evaluation condition defined in advance of the plurality of users for whom the matching is carried out by the matching unit 16 to evaluate the other users.

Here, the content of the evaluation condition is not limited particularly. However, it is preferable that the content is content by which other user can be evaluated objectively. As an example of the evaluation condition, there is a condition in which a predetermined relationship with an evaluation target (for example, a so-called friend relationship) is not set.

Further, the phrase “cause the user to evaluate the other users” means that the user is caused to input evaluation of other user. A configuration to cause the user to evaluate other user is not limited particularly. However, it is preferable that the configuration is a configuration in which a side that evaluates does not feel an excessive load or responsibility. As an example of such a configuration, there is a configuration in which a game screen in which other user can be evaluated by selecting one choice from choices of the predetermined number is provided to the user.

The updating unit 18 has a function to update information regarding evaluation of the user (hereinafter, referred to as “evaluation information”) on the basis of an evaluation result by the evaluating unit 17.

Here, the evaluation result means the content that is inputted by the user as evaluation to the other users. A configuration to update the evaluation information of the user evaluated on the basis of the evaluation result is not limited particularly. However, it is preferable that the configuration is a configuration in which multiple evaluation results are accumulated or reflected. As an example of such a configuration, there is a configuration in which a numerical value corresponding to an evaluation result is accumulated as a numerical value (evaluation value) for identifying evaluation of a user. In this case, at least an evaluation value is contained in the evaluation information.

The leader setting unit 13C has a function to refer to the evaluation information to set the user to a leader.

Here, the phrase “refer to the evaluation information to set” means that it is determined whether the evaluation information corresponding to the user as the evaluation target satisfies a condition for becoming a leader or not, and the user is set to the leader in a case where it is determined that it satisfies the condition.

FIG. 9 is a flowchart showing an example of the game processing carried out by the server 10. In the game processing according to the present embodiment, processing related to evaluation of the user is carried out. Hereinafter, an operation of the server 10C will be described as an example. In this regard, explanation of the terminal 20 and/or a flowchart showing respective operations of the server 10C and the terminal 20 is omitted from a point of view to avoid repeated explanation.

In the game processing, the server 10C first carries out matching of a plurality of users (Step S3-101). In the present embodiment, the server 10C carries out matching of a plurality of users who satisfy a matching condition in accordance with a request from each of the users.

When the matching of the plurality of users is carried out, the server 10C evaluates a user (Step S3-102). In the present embodiment, the server 10C receives an input regarding evaluation to other user from a user who satisfies an evaluation condition of the plurality of matched users. Namely, the server 10C evaluates the user, who is the evaluation target, by using evaluation by a user other than the evaluation target.

When the user is evaluated, the server 10C updates evaluation information (Step S3-103). In the present embodiment, the server 10C updates the evaluation information so that an evaluation result obtained this time is reflected to the evaluation information corresponding to the user as the evaluation target.

As explained above, as one side of the third embodiment, the server 10C is configured so as to include the leader setting unit 13C, the matching unit 16, the evaluating unit 17, and the updating unit 18. Thus, the matching unit 16 carries out matching of the plurality of users; the evaluating unit 17 causes the user who satisfies the evaluation condition defined in advance of the plurality of matched users to evaluate other users; the updating unit 18 updates the information regarding evaluation of the users (the evaluation information) on the basis of the evaluation result; and the leader setting unit 13C refers to the evaluation information to set the user who satisfies the specific condition defined in advance to the leader. It is possible to cause a result obtained by causing a plurality of players who constitute a party to evaluate the other players each other to influence on setting of a user to a leader.

In this regard, it has not been mentioned particularly in the example of the third embodiment described above. However, the server 10C may be configured so as to: carry out matching of a plurality of users who constitute a party in advance with other users in accordance with a matching condition defined in advance; and cause the other user to evaluate at least a part of the plurality of users who constitute the party. Namely, for example, the server 10C may be configured so that, in a case where a party X, which each of a user A and a user B specifies the other to constitute, is matched with a user C, the user C is caused to evaluate the user A and the user B. In this regard, in this case, the server 10C may be configured so as to cause the user A and the user B to evaluate the user C. By configuring the server 10C in this manner, it is possible to prevent a situation that each of acquaintances values (or evaluates higher) the other acquaintances each other, and this makes it possible to cause the evaluation information to have objectivity.

### Fourth Embodiment

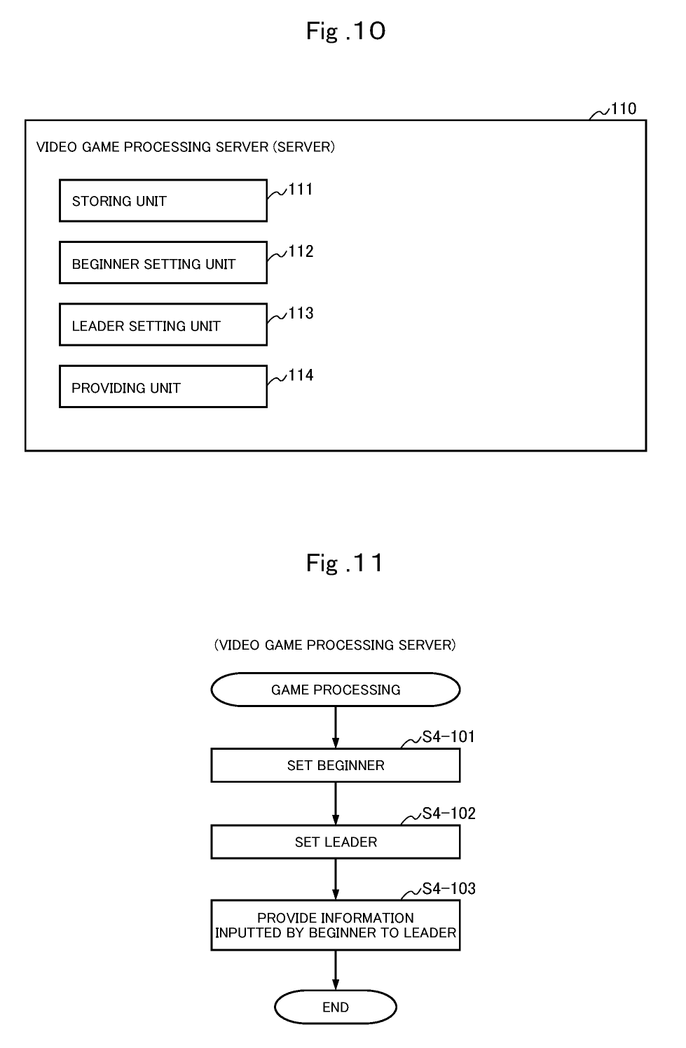

FIG. 10 is a block diagram showing a configuration of a video game processing server 110 (hereinafter, referred to as a “server 110”) to which the video game processing server 10 (for example, the servers 10A to 10C) can be applied. Namely, various kinds of elements or components in the example of each of the embodiments can become an element of the server 110 in a range where contradiction or the like does not occur. Hereinafter, the video game processing server 110 will be described. In this regard, explanation for a system and/or terminal to which a video game processing system 100 and/or the user terminal 20 can be applied is omitted from a point of view to avoid repeated explanation.

In the present embodiment, the server 110 at least includes a storing unit 111, a beginner setting unit 112, a leader setting unit 113, and a providing unit 114.

The storing unit 111 has a function to store party information, which indicate various kinds of information regarding each of parties constituted by a plurality of players in a video game.

The beginner setting unit 112 has a function to set a user who satisfies a predetermined condition defined in advance to a beginner.

The leader setting unit 113 has a function to set a user who satisfies a specific condition defined in advance to a leader.

The providing unit 114 has a function to provide the leader with information inputted by a beginner who is specified among beginners by the leader (hereinafter, referred to as “beginner input information”).

Here, a configuration to specify a beginner by the leader is not limited particularly. However, it is preferable that the configuration is a configuration in which the leader can identify whether to be the beginner who has already been specified by the leader or not. As an example of such a configuration, there is a configuration in which a game screen including information regarding a beginner who can be specified is provided to a leader.

Further, the beginner input information may be any one so long as it is information inputted as information that can be provided to a leader by a beginner. As an example of such information, there is character string that is inputted by a beginner as a question regarding the video game.

Further, a configuration to provide the beginner input information to the leader is not limited particularly. However, it is preferable that the configuration is a configuration in which provision targets including the leader who specifies the beginner can recognize the beginner who inputs the beginner input information. As an example of such a configuration, there is a configuration in which the beginner input information and identification information of the beginner (for example, a question and a questioner) are provided to the provision targets associated with the beginner. In this regard, a configuration to associate the beginner with the provision targets is not limited particularly. However, it is preferable that the configuration is a configuration in which at least one beginner is associated with one leader. As an example of such a configuration, there is a configuration in which a plurality of beginners and a plurality of leaders are associated with each other and stored in a predetermined storage region. Further, a configuration of the provision target is not limited particularly. However, it is preferable that it includes at least one leader. As an example of the provision target, there is a gathering of a leader and other beginners who play the video game in the same virtual space.

FIG. 11 is a flowchart showing an example of the game processing carried out by the server 110. In the game processing according to the present embodiment, processing related to providing of the beginner input information to the leader is carried out.

In the game processing, the server 110 first sets a beginner (Step S4-101), and then sets a leader (Step S4-102).

When the beginner and the leader are set, the server 110 provides information inputted by the beginner to the leader (Step S4-103). In the present embodiment, the server 110 transmits at least part of the information that is received from the terminal operated by the beginner to at least terminals operated by provision targets including the leader who specifies the beginner.

As explained above, as one side of the fourth embodiment, the server 110 is configured so as to include the beginner setting unit 112, the leader setting unit 113, and the providing unit 114. Thus, the beginner setting unit 112 sets the user who satisfies the predetermined condition defined in advance to the beginner; the leader setting unit 113 sets the user who satisfies the specific condition defined in advance to the leader; and the providing unit 114 provides the leader with the information inputted by the beginner who is specified by the leader of the beginners. Therefore, it is possible to encourage intercommunion between the leader and the beginner.

In this regard, it has not been mentioned particularly in the example of the fourth embodiment described above. However, the server 110 may be configured so as to provide the beginner with information inputted by the leader (hereinafter, referred to as “leader input information”). By configuring the server 110 in this manner, it is possible to encourage intercommunion in the form that the leader gives a reply to the beginner. In this regard, a configuration to provide the beginner with the leader input information is not limited particularly. However, it is preferable that the configuration is a configuration in which the beginner can recognize who inputs the leader input information. As an example of such a configuration, there is a configuration in which a channel for a so-called chat including beginners of the predetermined number and a leader is provided.

In this regard, it has not been mentioned particularly in the example of the fourth embodiment described above. However, the server 110 may be configured so as to refer to a storing unit configured to store information by which it is possible to identify whether each of the users is a beginner, a leader, or neither the leader or beginner (or a person other than the beginner and the leader, hereinafter, referred to as “other person”) and not to provide information inputted by the beginner to the other person. By configuring the server 110 in this manner, it is possible to reduce a load when the beginner inputs a question or the like. Namely, since the beginner does not have to worry that a response is transmitted from a person other than a person who is thought to have fixed reliability or more (that is, the leader), it is possible to reduce a psychological burden and the like. In this case, the server 110 maybe configured so as not to provide information inputted by the leader (in particular, an answer to the information inputted by the beginner) to the other person. Further, the server 110 may be configured so that the beginner or leader can specify a person to whom he or she wants to provide information inputted by himself or herself or a person who may receive provision of inputted information among the beginners and the leader. In this case, the server 110 may be configured so as to: refer to specified information corresponding to a person who inputs information (that is, information regarding a person who wants to provide information or a person who may receive provision of information) when input of information by the beginner or the leader is received; and provide the information. However, it is preferable that fixed restriction is imposed on the specified information in order to prevent a situation that the leader never receives provision of information.

In this regard, it has not been mentioned particularly in the example of the fourth embodiment described above. However, the server 110 may be configured so as to arrange one or more leader and beginners specified by the one or more leader in a virtual space in which the leader and the beginners can be arranged (a so-called chat room or channel) (hereinafter, a virtual space including a beginner may be referred to as a “beginner channel”). By configuring the server 110 in this manner, it is possible to encourage freer intercommunion between the leader and the beginner. In this regard, a configuration of the virtual space is not limited particularly. For example, the server 110 may be configured so as to set an upper limit of persons and/or a breakdown of an upper limit of beginners and an upper limit of leaders to the virtual space.

In this regard, it has not been mentioned particularly in the example of the fourth embodiment described above. However, the server 110 may be configured so as to include a leader as a provision target of information inputted by a beginner when the leader logs in the video game. By configuring the server 110 in this manner, it is possible to encourage a leader to have a fixed sense of duty. In this case, for example, the server 110 may be configured so as to release or change the setting in a case where a user who satisfies a resignation condition defined in advance is set to a leader.

In this regard, it has not been mentioned particularly in the example of the fourth embodiment described above. However, the server 110 may be configured so as to release or change the setting in a case where a user who satisfies a release condition defined in advance is set to a beginner. The content of the release condition is not limited particularly. For example, there is one regarding a time when to play the video game. By configuring the server 110 in this manner, it is possible to prevent users who are kept being set to beginners from becoming excessive. In this regard, by being configured so that with respect to a user who does not become a beginner, a process as a beginner (for example, participation in the beginner channel) is not carried out at the time of next log-in after the beginner logged out, it is possible to reduce a load on the server compared with the case where the process (for example, immediate forcible removal from the beginner channel) is carried out in real-time when a user does not become a beginner.

In this regard, it has not been mentioned particularly in the example of the fourth embodiment described above. However, the server 110 may be configured so as to prohibit a beginner specified by a leader from inputting information that can be provided to the leader. By configuring the server 110 in this manner, it is possible to prevent a trouble between users in advance. In this case, it is preferable that a configuration to avoid a trouble (for example, a request to input reasons to store or remove a history) is provided in order for a leader to specify a beginner.

In this regard, it has not been mentioned particularly in the example of the fourth embodiment described above. However, the server 110 may be configured so as to cause a leader and a beginner to share a game screen in which information inputted by the leader and information inputted by the beginner are shown in a different form. In this case, it is preferable that an area to display a state of each of the users, such as whether to log in the video game or not, is provided on the game screen.

### Fifth Embodiment

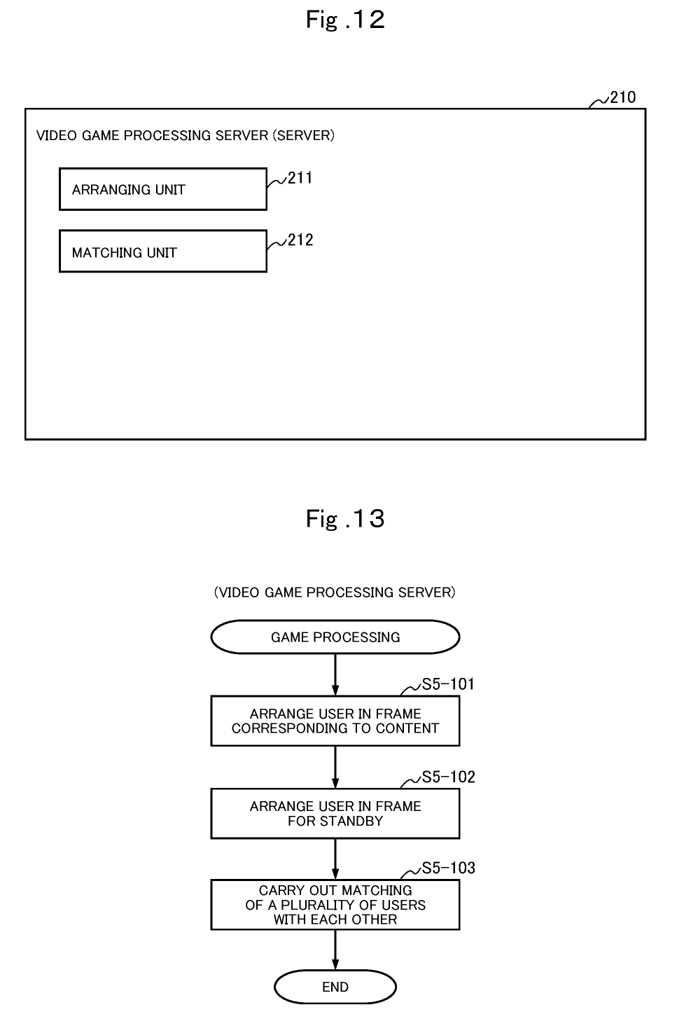

FIG. 12 is a block diagram showing a configuration of a video game processing server 210 (hereinafter, referred to as a “server 210”) to which the video game processing server 10 (for example, any of the servers 10A to 10C) can be applied. Namely, various kinds of elements or components in the example of each of the embodiments can become an element of the server 210 in a range where contradiction or the like does not occur. Hereinafter, the video game processing server 210 will be described. In this regard, explanation for a system and/or terminal to which the video game processing system 100 and/or the user terminal 20 can be applied is omitted from a point of view to avoid repeated explanation.

In the present embodiment, the server 210 at least includes an arranging unit 211 and a matching unit 212.

The arranging unit 211 has a function to arrange a user or users who carries out or carry out a play request for content in a video game in a frame corresponding to the content.

Here, the content means one unit of a service in the video game. The configuration of the content is not limited particularly. However, it is preferable that an end condition for it is defined. As examples of the content, there are one that a user plays by oneself, and another one that users of the predetermined number play at the same time. Further, as examples of the content that a plurality of users plays at the same time, there are content in which a plurality of users cooperates with each other, and content in which users fight each other.

Further, the frame corresponding to the content is one used for matching of a plurality of users on the basis of a matching condition set to the content. The number of frames corresponding to one content is not limited particularly, but it may be the singular number.

Further, the phrase “arrange in the frame” means that the order of the users is determined, and the users are arranged. The configuration to arrange the user or users in the frame is not limited particularly. However, it is preferable that the configuration is a configuration in which an exception can be provided while in principle arranging the users in the order to carry out the play request for the content. In this regard, the server 210 may be configured so that identification information of each of users, identification information of a frame, and an order thereof are managed to be associated with each other without arranging the users in the form that each of the users can recognize, for example.

Moreover, the arranging unit 211 has a function to arrange a user or users who carries out or carry out a play request by which no content is specified in a frame for standby.

Here, the phrase “frame for standby” means a frame that is provided for standby in addition to the frame corresponding to the content. Namely, in the present embodiment, the arranging unit 211 pools a part of users for matching. A configuration of the frame for standby is not limited particularly so long as it is a different frame from the frame corresponding to the content (in particular, a frame for which a relationship for one-to-one correspondence with the content is defined). As an example of the frame for standby, there is one to which a property common to a plurality of contents, such as a type of content or a handling level, is set.

The configuration to arrange the user in the frame for standby is not limited particularly. However, it is preferable that users are arranged so that a user who carried out a play request earlier is matched with other user earlier. As an example of such a configuration, there is a configuration in which users are arranged in order for the user to carry out a play request.

The matching unit 212 has a function to carry out matching of a plurality of users, who satisfy a predetermined matching condition, in turn from the head of a line (user line) that is composed of the plurality of users who is arranged by the arranging unit 211 in the frame.

Here, the matching condition means a condition by which the plurality of users is caused to carry out matching. The content of the matching condition is not limited particularly. However, it is preferable that the matching condition is the content that is related to an attribute of a user (for example, a role, a job, a property or the like in the video game) and in which users of the predetermined number including two or more users to which different attributes are set each other are matched. As an example of the matching condition, there is a condition of “a user with an attribute A, a user with an attribute B or an attribute C, and a user with an attribute D”.

Further, the phrase “carry out matching in turn from the head of the line” means that a plurality of users who satisfies the matching condition is determined and matching of them is carried out from the head of the line arranged by the arranging unit 211. Namely, a user positioned at a front part of the line is matched preferentially. In this regard, the configuration to carry out matching of the plurality of users in turn from the head of the line is not limited particularly. However, it is preferable that in a case where a plurality of frames is associated with one content, users respectively positioned at the heads of the plurality of frames are matched each other. As examples of the configuration to carry out matching of the plurality of users in turn from the head of the line, there are a configuration in which it is determined that users respectively positioned at the heads of a plurality of frames corresponding to content satisfy a matching condition, and a configuration in which a plurality of users who satisfies a condition is extracted from a line.

Moreover, the matching unit 212 has a function to carry out matching of a user who is arranged in a frame corresponding to content (hereinafter, referred to as a “content arranged user”) with a user who is arranged in the frame for standby (waiting user).

Here, the configuration to carry out matching of the content arranged user with the waiting user is not limited particularly. However, it is preferable that the configuration is a configuration in which a plurality of users thus matched can play the content corresponding to the content arranged user. As an example of such a configuration, there is a configuration in which matching of a content arranged user who is arranged in a frame and whose waiting time for matching is long with a waiting user is carried out preferentially.

FIG. 13 is a flowchart showing an example of the game processing carried out by the server 210. In the game processing according to the present embodiment, processing related to matching of a plurality of users is carried out.

In the game processing, the server 210 first arranges a user who carries out a play request for content in a frame corresponding to the content (Step S5-101). In the present embodiment, the server 210 arranges the user who carries out the play request by which the content is specified (or a condition is presented) in a frame corresponding to an attribute of the user in the specified content (or one or more content that satisfies the condition). Namely, for example, in a case where the attribute of the user who carries out the play request is the attribute A and five contents are extracted, the server 210 arranges the user in each of frames for the attribute A, which respectively correspond to the five contents.

Further, the server 210 arranges a user who carries out a play request by which no content is specified in a frame for standby (Step S5-102). In the present embodiment, the server 210 arranges a user who carries out a play request by which no content is specified in the frame for standby in order for the user to carry out the play request.

When the users are arranged in accordance with the play requests, the server 210 carries out matching of a plurality of users who satisfy a matching condition (Step S5-103). In the present embodiment, the server 210 first carries out matching of a plurality of users in a case where the plurality of users arranged in one content satisfies a matching condition corresponding to the content, and causes them to play the content as one group. On the other hand, in a case where the plurality of users arranged in one content does not satisfy the matching condition corresponding to the content, the server 210 confirms whether a user who may satisfy the matching condition is arranged in the frame for standby or not. Here, in a case where a plurality of users who satisfy the matching condition corresponding to the content becomes complete by including the user arranged in the frame for standby, the server 210 carries out matching of one or more user arranged in the frame corresponding to the content with one or more user arranged in the frame for standby, and causes them to play the content as one group.

As explained above, as one side of the fifth embodiment, the server 210 is configured so as to include the arranging unit 211 and the matching unit 212. Thus, the arranging unit 211 arranges a user who carries out a play request for content in the video game in a frame corresponding to the content; the matching unit 212 in turn carries out matching of a plurality of users who satisfies a predetermined matching condition from the head of a line constituted in a frame by the plurality of arranged users; the arranging unit 211 further arranges a user who carries out a play request by which no content is specified in the frame for standby; and the matching unit 212 carries out matching of the user arranged in the frame corresponding to the content with the user arranged in the frame for standby. Therefore, it is possible to shorten a time required for the matching.

In this regard, it has not been mentioned particularly in the example of the fifth embodiment described above. However, the server 210 may be configured so as to: arrange a user who carries out a play request that aims at assist of other user in a frame for assist; and carry out matching of a user arranged in a frame corresponding to content with the user arranged in the frame for assist. By configuring the server 210 in this manner, it is possible to carry out the matching quickly while meeting the demand of the players even in a case where the number of users arranged in the frame corresponding to the content is low. Namely, it is possible to realize a system capable of shortening a time required to carry out matching while responding a request of a player who wants to help other person.

In this regard, it has not been mentioned particularly in the example of the fifth embodiment described above. However, the server 210 may be configured so as to: set a user who satisfies a predetermined condition defined in advance to a beginner; set a user who satisfies a specific condition defined in advance to a leader; arrange a leader who carries out a play request that aims at assist of other user in a frame for assist; and carry out, in a preferential manner, matching of the beginner arranged in the frame corresponding to the content with the leader arranged in the frame for assist compared with at least matching of the leaders. By configuring the server 210 in this manner, it is possible to further encourage intercommunion between the leader and the beginner.

Here, the configuration to carry out, in a preferential manner, matching of the beginner with the leader compared with matching of the leaders is not limited particularly. However, it is preferable that the configuration is a configuration in which it is limited that leaders of predetermined number or more belong to a group constituted by matching or the leaders of a predetermined ratio or more belong to the group. As an example of such a configuration, there is a configuration in which when to create a group of four users by matching, a condition that three or more leaders cannot belong to the same group is included in the matching condition.

In this regard, it has not been mentioned particularly in the example of the fifth embodiment described above. However, the server 210 may be configured so as to give a priority to carry out matching of a beginner who is arranged in a frame corresponding to content that satisfies a leading condition of a plurality of contents with a leader who is arranged in the frame for standby or a frame for assist compared with other matching. By configuring the server 210 in this manner, it is possible to enhance an effect to provide a leader. Here, the content of the leading condition is not limited particularly. However, it is preferable that content, which is thought to have a higher demand to receive coaching, is contained in the plurality of contents. As examples of the leading condition, there are a condition that the content is content to be cleared to cause a story provided in the video game to proceed and a condition that it is not content in which a plurality of users fights against each other (so-called PvP content). Further, the server 210 may be configured so as to contain the degree of difficulty of content in the leading condition. Further, the server 210 may be configured so that a user set to a leader is not matched with a user arranged in a frame corresponding to content that the user has never cleared.

In this regard, it has not been mentioned particularly in the example of the fifth embodiment described above. However, the server 210 may be configured so as to give a privilege to a leader who satisfies an achievement condition regarding matching with a beginner among leaders. By configuring the server 210 in this manner, it is possible to encourage the leader to participate in the content together with the beginner. Here, as an example of the achievement condition, the number of times of matching with a beginner and the number of times to clear the content played together with a beginner.

### Sixth Embodiment

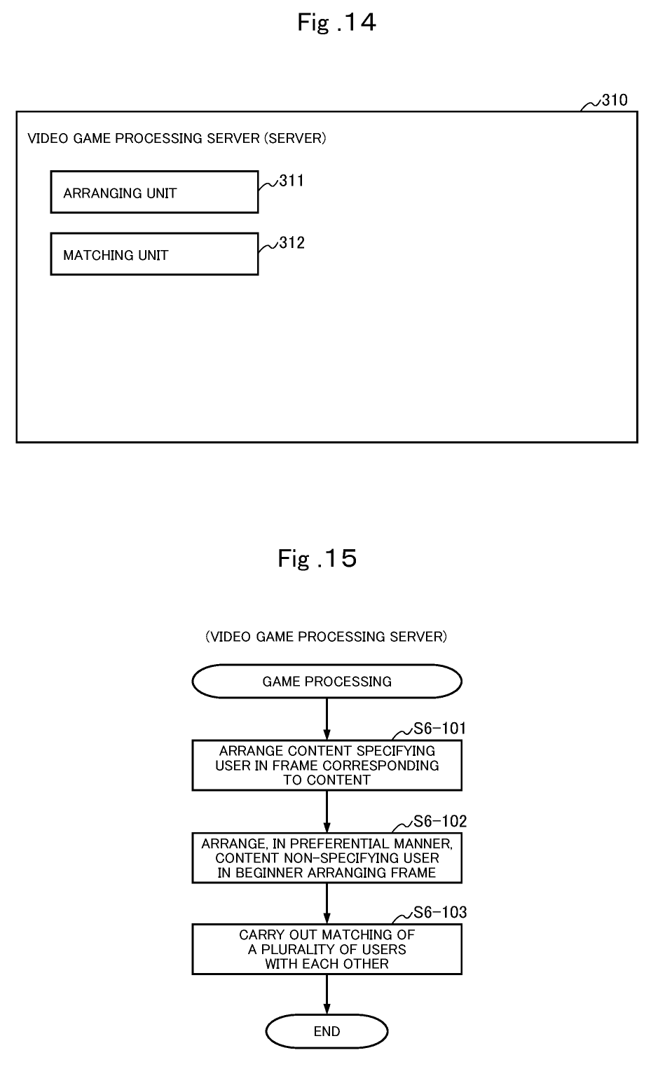

FIG. 14 is a block diagram showing a configuration of a video game processing server 310 (hereinafter, referred to as a “server 310”) to which the video game processing server 10 (for example, any of the server 10A to 10C) can be applied. Namely, various kinds of elements or components in the example of each of the embodiments can become an element of the server 310 in a range where contradiction or the like does not occur. Hereinafter, the video game processing server 310 will be described. In this regard, explanation for a system and/or terminal to which a video game processing system 100 and/or a user terminal 20 can be applied is omitted from a point of view to avoid repeated explanation.

In the present embodiment, the server 310 at least includes an arranging unit 311 and a matching unit 312.

The arranging unit 311 has a function to arrange a user who carries out a play request for content in a video game in a frame corresponding to the content. Here, the play request for the content is a play request in which at least one content is specified.

Moreover, the arranging unit 311 has a function to give a priority to arrange a user who carries out a play request by which no content is specified in a frame in which a user (beginner) who satisfies a condition for identifying that the user is a beginner of the video game is arranged.

Here, the “frame in which the beginner is arranged” means a frame in which a beginner who is in a state of waiting for matching to play content is arranged.

Further, the configuration to give a priority to arrange a user in a frame in which a beginner is arranged is not limited particularly. However, it is preferable that the configuration is a configuration in which even in a case where there is no frame in which a beginner is arranged, a user can be arranged in any frame. As an example of such a configuration, there is a configuration in which with respect to a user who carries out a play request by which no content is specified, it is first determined whether the user can be arranged in content in which a beginner is arranged or not; the user is arranged in a case where the user can be arranged; and content in which the user is arranged is determined in accordance with other conditions in a case where the user cannot be arranged.

The matching unit 312 has a function to in turn carry out matching of a plurality of users who satisfy a predetermined matching condition from the head of a line (user line) constituted in the frame by the plurality of users arranged by the arranging unit 311.

FIG. 15 is a flowchart showing an example of the game processing carried out by the server 310. In the game processing according to the present embodiment, processing related to matching of a plurality of users with each other is carried out.

In the game processing, the server 310 first arranges a user who carries out a play request for content (a content specifying user) in a frame corresponding to the content (Step S6-101). In the present embodiment, the server 310 arranges the user in the frame corresponding to the content specified by the user.

Further, the server 310 arranges, in a preferential manner, a user who carries out a play request by which no content is specified (content non-specifying user) in a frame in which beginners are arranged (beginner arranging frame) (Step S6-102). In the present embodiment, the server 310 arranges the content non-specifying user in the frame in accordance with a predetermined arrangement rule including a rule regarding the frame in which the beginners are arranged.

When the users are arranged in accordance with the play request, the server 310 carries out matching of a plurality of users who satisfies a matching condition (Step S6-103). In the present embodiment, the server 310 carries out matching of the plurality of users who satisfy the matching condition of the plurality of users arranged in the frame corresponding to the same content; and causes them to play the content as one group.

As explained above, as one side of the sixth embodiment, the server 310 is configured so as to include the arranging unit 311 and the matching unit 312. Thus, the arranging unit 311 arranges the user who carries out the play request of the content in the video game in the frame corresponding to the content; the matching unit 312 in turn carries out matching of the plurality of users who satisfy the predetermined matching condition from the head of the line constituted in the frame by the plurality of arranged users; and the matching unit 312 gives a priority to arrange the user who carries out the play request by which no content is specified in a frame in which a user who satisfies a condition for identifying that the user is a beginner of the video game is arranged. Therefore, it is possible to shorten an amount of time required until the beginner is matched with other user. Namely, a probability that other user is arranged in the frame in which a beginner is arranged is heightened. For this reason, it is possible to shorten a time required until a plurality of users including a beginner in the same frame satisfies the matching condition.

As explained above, one or two or more shortages are solved by each of the embodiments of the present application. In this regard, the effects by each of the embodiments are non-limiting effects or one example of the non-limiting effects.

In this regard, it has not been mentioned particularly in each of the embodiments described above. However, the server may be configured so that a different privilege is given to a plurality of users between the case where a beginner and a leader are matched to play the same content and the case where at least one of a beginner and a leader requests or proposes the other to play the same content together. Namely, the server may be configured so as to refer to a process to create a party including a beginner and a leader to differentiate handling of the party. By configuring the server in this manner, it is possible to further encourage intercommunion between the beginner and the leader. For example, by configuring the server so as to lower or strip off the value of a privilege in a case where a party is created by chance (for example, in a case where a beginner and a leader are matched by a matching function), it is possible to encourage active intercommunion between the beginner and the leader compared with the case where a beginner or a leader actively creates a party.

In this regard, in each of embodiments described above, each of the plurality of user terminals 20, 201 to 20N and the server 10 carries out the various kinds of processing described above in accordance with various kinds of control programs (for example, a video game processing program) stored in the storage device with which the corresponding terminal or server is provided.

Further, the configuration of the system 100 is not limited to the configuration that has been explained as the example of the respective embodiments described above. For example, the server 10 may be configured so that a part or all of the processing that have been explained as the processing carried out by the user terminal is carried out by the server 10. Alternatively, the system 100 may be configured so that a part or all of the processing that have been explained as the processing carried out by the server 10 is carried out by any of the plurality of user terminals 20 and 201 to 20N (for example, the user terminal 20). Further, the system 100 may be configured so that a part or all of the storage sections included by the server 10 is included in any of the plurality of user terminals 20 and 201 to 20N. Namely, the system 100 may be configured so that a part or all of the functions included in any one of the user terminal 201 and the server 10 according to the system 100 is included in the other. This is also similar to the system that includes the server 210 and the server 310.

Further, the program may be configured so as to cause a single apparatus that does not include a communication network to realize a part or all of the functions, which have been explained as the examples of the respective embodiments described above.

In this regard, the phrase “in accordance with progress of the video game” means that occurrence of various kinds of progress or changes and the like that can be generated in the video game becomes timing or a standard of the processing of specifying. As an example of the processing of specifying, there are a determining process, an information updating process and the like. Further, as examples of the various kinds of progress or changes that can be generated in the video game, there are progress of time, a change in the game element value, a specific status or update of a flag, an operation input by the user, and the like.

### Appendix

The explanation of the embodiments described above has been described so that the following inventions can be at least realized by a person having a normal skill in the art to which the present invention belongs.
(1)

A video game processing program for causing a server to realize functions to control progress of a video game in response to an operation of a user,

wherein the functions include:

a beginner setting function configured to set a user who satisfies a predetermined condition defined in advance to a beginner;

a leader setting function configured to set a user who satisfies a specific condition defined in advance to a leader; and

a privilege giving function configured to give a privilege to at least a part of a plurality of users who constitute a party including the leader and the beginner among parties each of which is constituted by a plurality of users.
(1-1)

The video game processing program according to (1),

wherein the functions further include:

a matching function configured to carry out matching of a plurality of users;

an evaluating function configured to cause a user who satisfies an evaluation condition defined in advance to evaluate the other users, the user being one of the plurality of users who are subjected to the matching by the matching function; and

an updating function configured to update information regarding evaluation of the users (hereinafter, referred to as “evaluation information”) on the basis of an evaluation result by the evaluating function,

wherein the leader setting function includes a function configured to refer to the evaluation information to carry out the setting.
(1-2)

The video game processing program according to (1-1),

wherein the matching function includes a function configured to carry out matching of a plurality of users who constitute a party in advance with other users in accordance with a matching condition defined in advance, and

wherein the evaluating function includes a function configured to cause the other users to evaluate at least a part of the plurality of users who constitute the party.
(2)

The video game processing program according to (1),

wherein the leader setting function includes a function configured to determine whether the specific condition is satisfied or not in response to a setup request from a user terminal.
(3)

The video game processing program according to (1),

wherein the leader setting function includes a function configured to determine whether the specific condition is satisfied or not when it becomes specific timing.
(4)

The video game processing program according to any one of (1) to (3),

wherein the functions further include:

an informing function configured to inform the server of being the leader.
(5)

A video game processing program for causing a server to realize functions to control progress of a video game in response to an operation of a user,

wherein the functions include:

a beginner setting function configured to set a user who satisfies a predetermined condition defined in advance to a beginner;

a leader setting function configured to set a user who satisfies a specific condition defined in advance to a leader; and

a providing function configured to provide information to the leader, the information being inputted by a beginner who is specified by the leader among beginners.
(5-1)

The video game processing program according to (5),

wherein the providing function includes a function configured to provide information inputted by the leader to the beginners.
(6)

A video game processing program for causing a server to realize functions to control progress of a video game in response to an operation of a user,

wherein the functions include:

an arranging function configured to arrange a user who carries out a play request for content in the video game in a frame corresponding to the content; and

a matching function configured to in turn carry out matching of a plurality of users from a head of in a line, the line being constituted in the frame by the plurality of users arranged by the arranging function, the plurality of users satisfying a predetermined matching condition,

wherein the arranging function includes a function configured to arrange a user who carries out a play request by which the content is not specified in a frame for standby, and

wherein the matching function includes a function configured to carry out matching of the user arranged in the frame corresponding to the content with the user arranged in the frame for standby.
(6-1)

The video game processing program according to (6),

wherein the arranging function includes a function configured to arrange a user who carries out a play request that aims at assist of other user in a frame for assist, and

wherein the matching function includes a function configured to carry out matching of the user arranged in the frame corresponding to the content with the user arranged in the frame for assist.
(6-2)

The video game processing program according to (6-1),

wherein the functions further include:

a beginner setting function configured to set a user who satisfies a predetermined condition defined in advance to a beginner; and

a leader setting function configured to set a user who satisfies a specific condition defined in advance to a leader,

wherein the arranging function includes a function configured to arrange a leader who carries out the play request that aims at assist of the other user in the frame for assist, and

wherein the matching function includes a function configured to carry out, in a preferential manner, matching of a beginner arranged in the frame corresponding to the content with a leader arranged in the frame for assist compared with at least matching of leaders.
(7)

A video game processing program for causing a server to realize functions to control progress of a video game in response to an operation of a user,

wherein the functions include:

an arranging function configured to arrange a user who carries out a play request for content in the video game in a frame corresponding to the content; and

a matching function configured to in turn carry out matching of a plurality of users from a head of in a line, the line being constituted in the frame by the plurality of users arranged by the arranging function, the plurality of users satisfying a predetermined matching condition,

wherein the arranging function includes a function configured to give a priority to arrange a user who carries out a play request by which the content is not specified in a frame in which a user who satisfies a condition for identifying that the user is a beginner of the video game is arranged.
(8)

A video game processing program for causing a user terminal to realize at least one function of the functions that the video game processing program according to any one of (1) to (7) causes the server to realize, the user terminal being capable of communicating with the server.
(9)

A server into which the video game processing program according to any one of (1) to (8) is installed.
(10)

A video game processing system for controlling progress of a video game in response to an operation of a user, the video game processing system including a communication network, a server, and a user terminal, the video game processing system comprising:

a beginner setting unit configured to set a user who satisfies a predetermined condition defined in advance to a beginner; a leader setting unit configured to set a user who satisfies a specific condition defined in advance to a leader (or a mentor); and

a privilege giving unit configured to give a privilege to at least a part of a plurality of users who constitute a party including the leader and the beginner among parties each of which is constituted by a plurality of users.
(11)

The video game processing system according to (10),

wherein the server includes the beginner setting unit, the leader setting unit, and the privilege giving unit, and

wherein the user terminal includes:

an outputting unit configured to output a game screen to a display screen of a display device by transmitting and receiving information regarding the video game.
(12)

A video game processing program for causing a user terminal to realize functions to control progress of a video game in response to an operation inputted into the user terminal by a user,

wherein a server includes:

a beginner setting function configured to set a user who satisfies a predetermined condition defined in advance to a beginner;

a leader setting function configured to set a user who satisfies a specific condition defined in advance to a leader; and

a privilege giving function configured to give a privilege to at least a part of a plurality of users who constitute a party including the leader and the beginner among parties each of which is constituted by a plurality of users, and

wherein the functions include:

a function configured to receive information regarding the functions included by the server from the server; and

a function configured to carry out input and output corresponding to the functions.
(13)

A video game processing program for causing a user terminal to realize functions to control progress of a video game in response to an operation inputted into the user terminal by a user,

a beginner setting function configured to set a user who satisfies a predetermined condition defined in advance to a beginner;

a leader setting function configured to set a user who satisfies a specific condition defined in advance to a leader; and

a privilege giving function configured to give a privilege to at least a part of a plurality of users who constitute a party including the leader and the beginner among parties each of which is constituted by a plurality of users.
(14)

A video game processing program for causing a server to realize at least one function of the functions that the video game processing program according to (13) causes the user terminal to realize, the user terminal being capable of communicating with the server.
(15)

A user terminal into which the video game processing program according to any one of (12) to (14) is installed.
(16)

A video game processing method of controlling progress of a video game in response to an operation of a user, the video game processing method comprising:

a beginner setting process configured to set a user who satisfies a predetermined condition defined in advance to a beginner;

a leader setting process configured to set a user who satisfies a specific condition defined in advance to a leader; and

a privilege giving process configured to give a privilege to at least a part of a plurality of users who constitute a party including the leader and the beginner among parties each of which is constituted by a plurality of users.
(17)

A video game processing method carried out by a video game processing system for controlling progress of a video game in response to an operation inputted into the user terminal by a user, the video game processing system comprising a communication network, a server, and a user terminal, the video game processing method comprising:

a beginner setting process configured to set a user who satisfies a predetermined condition defined in advance to a beginner;

a leader setting process configured to set a user who satisfies a specific condition defined in advance to a leader; and

a privilege giving process configured to give a privilege to at least a part of a plurality of users who constitute a party including the leader and the beginner among parties each of which is constituted by a plurality of users.

### INDUSTRIAL APPLICABILITY

According to one of the embodiments of the present invention, it is useful to improve interest in or the taste of a video game in which a plurality of players who constitute a party cooperates with each other to solve various tasks.

### DESCRIPTION OF REFERENCE NUMERALS

10 server
20, 201 to 20N user terminal
11 storing unit
12 beginner setting unit
13 leader setting unit
14 privilege giving unit
15 informing unit
16 matching unit
17 evaluating unit
18 updating unit
30 communication network
100 system

1. A video game processing program for causing a server to realize functions to control progress of a video game in response to an operation of a user,
wherein the functions include:
a beginner setting function configured to set a user who satisfies a predetermined condition defined in advance to a beginner;
a leader setting function configured to set a user who satisfies a specific condition defined in advance to a leader; and
a privilege giving function configured to give a privilege to at least a part of a plurality of users who constitute a party including the leader and the beginner among parties each of which is constituted by a plurality of users.

2. The video game processing program according to claim 1,
wherein the leader setting function includes a function configured to determine whether the specific condition is satisfied or not in response to a setup request from a user terminal.

3. The video game processing program according to claim 1,
wherein the leader setting function includes a function configured to determine whether the specific condition is satisfied or not when it becomes specific timing.

4. The video game processing program according to claim 1,
wherein the functions further include:
an informing function configured to inform the server of being the leader.

5. A video game processing system for controlling progress of a video game in response to an operation of a user, the video game processing system including a communication network, a server, and a user terminal, the video game processing system comprising:
a beginner setting unit configured to set a user who satisfies a predetermined condition defined in advance to a beginner;
a leader setting unit configured to set a user who satisfies a specific condition defined in advance to a leader (or a mentor); and
a privilege giving unit configured to give a privilege to at least a part of a plurality of users who constitute a party including the leader and the beginner among parties each of which is constituted by a plurality of users.

6. The video game processing program according to claim 2,
wherein the functions further include:
an informing function configured to inform the server of being the leader.

7. The video game processing program according to claim 3,
wherein the functions further include:
an informing function configured to inform the server of being the leader.
